(19) United States
(12) Patent Application Publication
(10) Pub. No.: US 2003/0046297 A1
(43) Pub. Date: Mar. 6, 2003

(54) System and method for a partially self-training learning system

(75) Inventor: Zachary J. Mason, Portland, OR (US)

Correspondence Address: LAHIVE & COCKFIELD, 28 STATE STREET, BOSTON, MA, 02109, US

(73) Assignee: KANA SOFTWARE, INC., Natick, MA

(21) Appl. No.: 10/032,532

(22) Filed: Oct. 22, 2001

Related U.S. Application Data
(60) Provisional application No. 60/316,345, filed on Aug. 30, 2001.

(51) Int. Cl. G06F 17/00

(52) U.S. Cl. 707/102

(57) ABSTRACT

A method for a partially self-training learning system is disclosed. The learning systems, such as document classifiers, are initially trained on a small amount of hand-sorted data. The learning systems process unlabeled data by assigning classifications to the data. A confidence level in the classification is verified for each newly classified document. If the classification is made with a sufficiently high confidence level, the learning system trains on the word vector of the newly classified document. If the classification of the newly classified document is not made with a sufficiently high confidence level, the learning system does not use the word vector in the newly classified document for training purposes.

### RELATED APPLICATION

This application claims priority to co-pending U.S. Provisional Application No. 60/316,345 filed Aug. 30, 2001, for all subject matter common to both applications. The disclosure of said provisional application is hereby incorporated by reference in its entity.

### FIELD OF THE INVENTION

The illustrative embodiments of the present invention relate generally to learning systems and more particularly to self-training learning systems requiring only partial supervision.

### BACKGROUND OF THE INVENTION

Self-learning systems such as document classifiers attempt to classify documents without direct user input. A learning system must be “trained” on correct data. The term “trained” as applied herein indicates the process of building a mapping from the vocabulary in the training documents to a set of user-defined categories. The mapping is used to classify unlabelled documents. The data used in training a document classifier is usually furnished by a human operator of the system. Each datum consists of a labeled document and provides direction to the learning system on how to label unclassified documents.

Document classifiers such as naive-Bayes document classifiers attempt to classify unlabeled documents based on the presence of attributes within the document or collection of data. In the case of text documents, the attributes that are analyzed are the presence and/or absence of various words. Naive-Bayes document classifiers make the assumption that all of the words in a given document are independent of each other given the context of the class. Unfortunately, supervised learning systems such as naive-Bayes document classifiers suffer from the drawback that they are only as good as the data on which they are trained. The initial training of a document classifier is very labor intensive for the user as it requires a user to correctly label data for the learning system to train with before classification activities begin. The data must be correct, because if the document classifier trains on incorrect data, the accuracy of the classifier suffers.

### SUMMARY OF THE INVENTION

The illustrative embodiment of the present invention provides a method of training a learning system with a small collection of correct data initially, and then further training the learning system on automatically classified documents (as opposed to the human-classified initial training set) which the document classifier has determined are probably correct ( with the probability exceeding a parameter ). The confidence measure is expressed as a probability since the system will never be 100 percent accurate. The method greatly diminishes the system's demands for hand-classified data, which reduces the amount of human effort that must be put into training the system up to a certain accuracy. Furthermore, the method determines that a document classification meets a defined confidence parameter prior to being used as additional training material for the learning system.

In one embodiment of the present invention, a naive-Bayes document classifier is trained on an initial group of hand-sorted labeled data. The naive-Bayes document classifier is thereafter used to classify an unlabeled group of data. The classifier generates a confidence measure for each newly classified piece of previously unlabeled data. If the classifier is sufficiently confident in its classification of the unlabeled data, the classifier trains on the data. Since the classifier's categorization is not always correct, the classifier may train on mistakes thereby leading to performance degradation. In one aspect of the embodiment, the classifier's performance is continually checked against labeled training data. If the performance check determines that the classifier's performance has degraded, corrective action may be taken. The corrective action may include throwing out the changes made by training on (previously ) unlabeled data, and/or retraining the document classifier on the labeled data to increase the weight given to the labeled data.

### BRIEF DESCRIPTION OF THE DRAWINGS

FIG. 1 is a block diagram of an environment suitable for practicing an illustrative embodiment of the present invention;

FIG. 2 is a flow chart of the steps used to initially assign a category to an unclassified document;

FIG. 3 is a flow chart of the steps used to determine a confidence level in an assigned document classification using document word probability; and

FIG. 4 is a flow chart of the steps used to determine a confidence level in an assigned document classification using Average Mutual Information.

### DETAILED DESCRIPTION

Learning systems such as document classifiers enable the classification of documents without direct supervision by a user. Unfortunately, document classifiers must be trained before use. Conventional methods of initially training learning systems require user participation and are extremely time and labor intensive for the user. A bayesian document classifier works by first turning the document to be classified into a word vector, and then mapping this word vector to a category. A word vector is slightly different from a set of words. Elements of a word vector can be weighted, while those in a set generally can not be weighted. The characterization of a document as a word vector has the advantage that the space of all words is implicitly represented in the vector, with most words having a value of zero. This is important for the bayesian approach to classification, since evidence of the presence of a word is treated the same way as evidence of a word absence. The accuracy of the document classifier increases as the system is trained on more correctly labelled data. Under conventional methods of training Bayes document classifiers and other learning systems, it is necessary to hand-sort and label large amounts of data in order to train the classifiers sufficiently to map vocabulary words to document categories. The illustrative embodiment of the present invention enables a learning system, such as a Bayes document classifier, to accurately map learned vocabulary to document categories, thereby increasing accuracy with a minimal amount of hand-sorting of data during initial training. Additionally, the illustrative embodiment of the present invention further enables increasingly accurate mapping of words to categories by training on document classifier output in which confidence is sufficiently high.

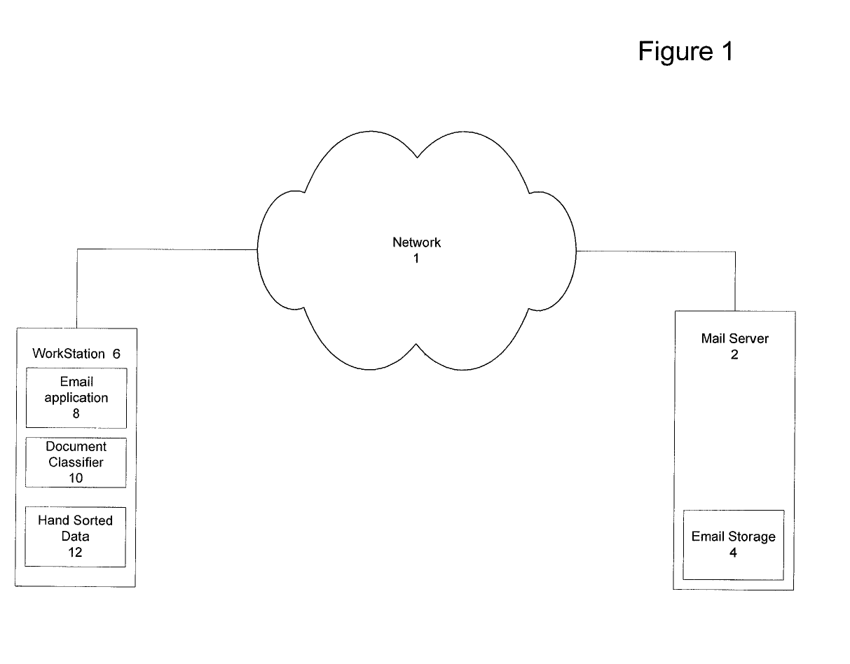

FIG. 1 depicts an environment suitable for practicing an illustrative embodiment of the present invention. A mail server 2 is connected to a network 1. The mail server 2 includes an email storage area 4 which stores a large volume of email messages intended for various recipients. Also attached to the network 1 is a work station 6. The work station 6 includes an email application 8, a document classifier 10, and a small amount of hand-sorted data 12 suitable for initially training the document classifier. Once the document classifier 10 has been trained using the hand-sorted data 12, an email message stored in the email storage area 4 on the mail server 2 may be retrieved over the network 1. Using the vocabulary learned from the hand-sorted data 12, the document classifier 10 classifies the email document.

The illustrative embodiments of the present invention increase the accuracy of the document classifier 10 or other learning system by allowing word vectors in documents classified by the document classifier to serve as training data for the purposes of increasing the accuracy of the document classifier. By enabling the document classifier 10 to train on its own classification, the need for large amounts of data hand-sorted by a user is avoided. In order to train on the previously unlabeled documents, however, the classifier first must be confident in the initial classification assigned to these previously unlabeled documents. Failure to verify the accuracy of document classifier generated classification prior to training may result in the deterioration of accuracy in the document classifier.

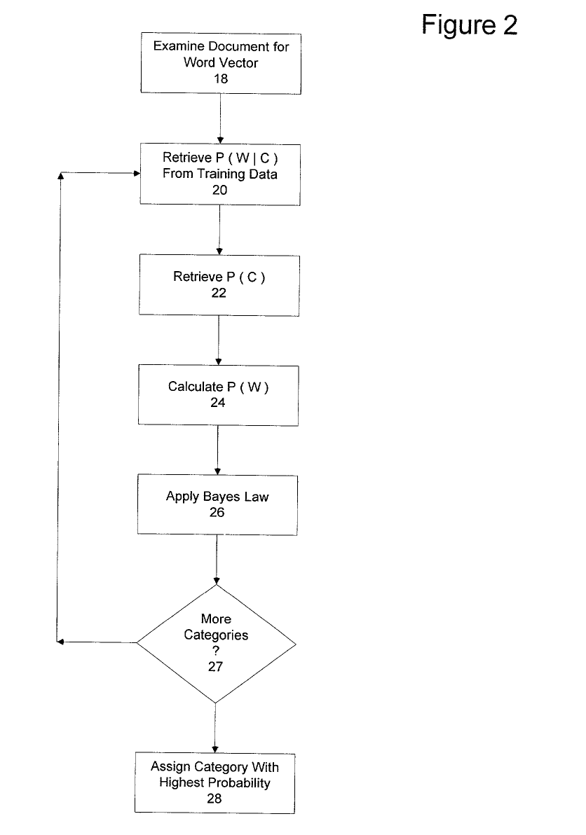

FIG. 2 is a flow chart of the steps followed by an illustrative embodiment of the present invention in initially classifying a document using a document classifier 10. The word vector appearing in the document is determined (step 18). Stop words are ignored. A “stop word” is a word that provides very little useful information to the document classifier because of the frequency with which it appears. Words such as “the”, “an”, “them”, etc., are classified as stop words. The training data is then consulted to determine the probability that a particular category C applies to the document given the word vector contained in the document (step 20). This step is abbreviated by the notation P (C|W) which is read as the probability that a document characterized by the word-vector W is of category C.” The probability of any particular document being a document of a particular category C, which is expressed by the notation P (C), is retrieved (step 22). The P (C) is a user-set parameter given to the document classifier. The a priori probability of the set of words W, which is expressed by the notation P(W) is estimated using an English frequency dictionary (step 24). Those skilled in the art will recognize that the process outlined herein may be applied to other languages in addition to English, as well as any strings of symbols drawn from a finite symbol set which satisfy the naïve-Bayes criterion. The naïve Bayes classifier is named after this step determining the P (W) since the step makes the “naïve” assumption that P (w_{—}1,w_{—}2 . . . w_n) is equal to P (w_{—}1) P (w_{—}2) . . . P(w_n). The notation P (W|C) denotes the probability that a randomly generated document from category C will be exactly the word vector W. Bayes law is then applied to determine a probability for the category C (step 26). Bayes law is given by the formula:

$$P ( C \vert W ) = \frac{P ( W \vert C ) P ( C )}{P ( W )}$$

The probability is estimated for each category (step 27). The category with the highest probability is assigned to the document (step 28).

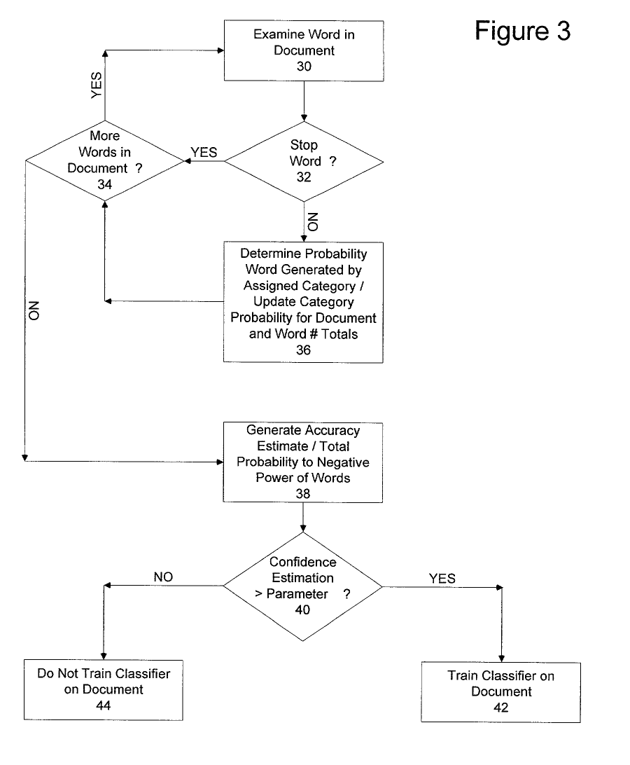

Once a category has been assigned to a document, the document classifier 10 must verify that it has sufficient confidence in the classification assigned to the word vector before the word vector is used to train the document classifier. FIG. 3 is a flowchart of the sequence of steps followed by the illustrative embodiment of the present invention to determine a confidence level in the category assigned to a document by the document classifier 10. Each word in the document is examined separately (step 30). A word is first examined to determine whether or not it is a “stop” word (step 32). If the word is a stop word, the next step determines whether there are additional unexamined words in the document (step 34). If there are additional words in the document, the next word is examined (step 30). If the word is not a stop word (step 32), the probability that the word was generated by its assigned category is determined (step 36). This is determined by referencing the frequency with which the particular word appeared in training documents of that category. The probability of each word in the document being in a document generated by that category is multiplied together to determine a total probability for the document being generated by the assigned category. “Those skilled in the art will recognize that the probability of a word vector W being generated by a category C is computed as the product of the probabilities of all the words in W being generated by C times the product of the probability of all the words not occurring in W not being generated by C. In order to minimize the time required to compute this probability, the negative evidence is often ignored.” A word counter tracking document length is also incremented. If there are additional unexamined words (step 34), the examination cycle repeats. If there are no more unexamined words in the document (step 34), a confidence estimate for the classification assigned to the document is generated by calculating the result of the document word probability taken to the power of 1 over the number of words in the document (step 38). This calculation takes into consideration the fact that the possibility of any word appearing in a document increases with document length. This is the inverse of the quantity known in the literature as the perplexity of the classification. The confidence estimate for the classification is compared against a predetermined parameter (step 40). The pre-determined parameter represents a confidence measurement based on the occurrence of words in training documents. If the confidence estimate for the classification is greater the the pre-defined parameter, the document classifier 10 uses the word vector in the newly classified document to train the classifier (step 42). If the confidence estimation for the classification is not greater than the pre-defined parameter, the word vector in the document is not used to train the document classifier (step 44). Those skilled in the art will recognize that the sequence of steps used to determine a confidence level for a categorization may be changed to require the confidence estimation exceed the pre-defined parameter (step 40) by one or two standard deviations or other amount. When the document classifier 10 is allowed to train on the new document (step 42), the words in the document are mapped to the assigned category thereby increasing the document classifier's accuracy. In some embodiments, the failure of a document classifier 10 to accurately classify a document leads to the document classifer being retrained on hand-sorted data. In other embodiments, two or more successive classification failures may be required before the document classifier is re-trained.

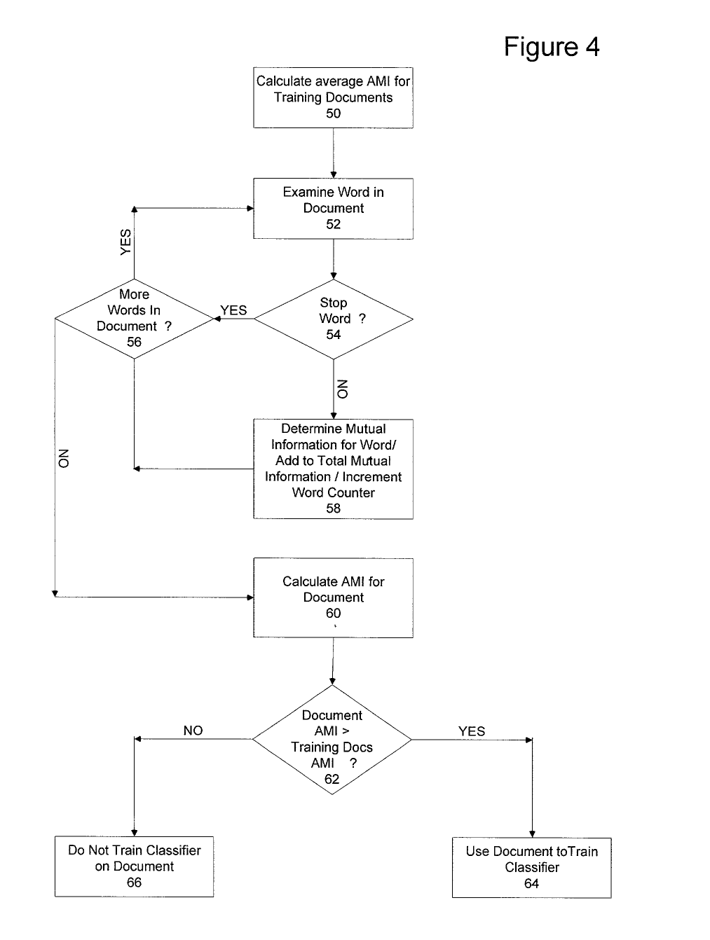

An alternative embodiment of the present invention which is used to verify a sufficient level of confidence in the assigned document classification prior to training the document classifier 10 on the document is depicted in the flowchart of FIG. 4. The average mutual information (AMI) for the document being classified is compared to the average of the AMI of all of the training documents initially used to train the document classifier 10. Mutual information (MI) is the degree of uncertainty in a classification that is resolved by knowing of the presence of a word in a document. Average mutual information is the average of the mutual information of all the words (except stop words) in a document. Mutual information is determined according to the formula:

MI(w)=H(C)−H(C|w)

MI (w) is interpreted as the amount of uncertainty in the classification of a random document that is resolved by knowing that the word w is in that document., H (C) is the amount of a priori uncertainty in the classification, and H(C|w) is the uncertainty regarding the classification of a document given that the word w is in the document. While all document classifications have a degree of uncertainty in them, the presence of a particular word in the document makes the classification less uncertain. The amount of uncertainty that is resolved by the presence of the individual word is based on the frequency of the appearance of the word in training documents having that classification. AMI is determined by adding up the total MI for all of the words in a document and dividing it by the number of words in the document.

FIG. 4 depicts the sequence of steps followed in the illustrative embodiment of the present invention to determine a confidence level in a document classification by using AMI. The sequence begins by calculating the average AMI for all of the training documents (step 50) as described above. A word in a document that has been classified by the document classifier is then examined (step 52). A determination is made as to whether or not the word is a stop word (step 54). If the word is a stop word (step 54), a determination is made as to whether or not there are any unexamined words in the document (step 56). If the document is not a stop word (step 54) the mutual information is determined as outlined above and added to a cumulative total for the document. A word counter tracking the document length is also incremented (step 58). If there are more unexamined words in the document (step 56), the cycle repeats. If there are not any more unexamined words, the AMI for the whole document is determined by dividing the accumulated mutual information by the value of the word counter (step 60). The resulting AMI for the document is compared with the average AMI for all of the training documents (step 62). If the AMI is one standard deviation above the mean AMI for the training documents (step 62), the document classifier 10 has a sufficient level of confidence in the document classification to use the word vector from the document for training (step 64). If the AMI is not one standard deviation above the mean AMI for the training documents, the word vector in the document is not used to train the document classifier 10 (step 66). Those skilled in the art will recognize that the step of comparing the document AMI to the mean AMI for the training documents (step 62) may be adjusted to require the AMI to exceed the average AMI of the training documents by two standard deviations or other specified amounts. Additionally, the confidence level determinations depicted in FIG. 3 and FIG. 4 may be used in combination with each other or other similar procedures, thereby requiring a document classification to meet multiple standards before being used to train the document classifier 10. Those skilled in the art will further recognize that while the illustrations described herein have been made with reference to a document classifier 10, the method of the present invention is equally applicable to learning systems in general.

By providing a method to determine confidence levels in classifications performed by a document classifier, the embodiments of the present invention enable a potentially limitless supply of accurate training data to be used by a document classifier. Data which is verified as trustworthy is used to further build the document classifier vocabulary. The training of the classifier with additional data leads to improved accuracy in performance. The process of determining confidence levels in document classifications may be automated, thereby leading to the self-training of the document classifier without user participation. Word vectors in documents which are inaccurately classified or which have unknown trustworthiness are not used as training data. If the confidence level of the document classifier 10 falls below acceptable limits, the document classifier may be entirely retrained on the original hand-sorted data or an alternative set of hand-sorted data.

It will thus be seen that the invention attains the objects made apparent from the preceding description. Since certain changes may be made without departing from the scope of the present invention, it is intended that all matter contained in the above description or shown in the accompanying drawings be interpreted as illustrative and not in a literal sense. Practitioners of the art will realize that the system configurations depicted and described herein are examples of multiple possible system configurations that fall within the scope of the current invention. Likewise, the sequence of steps performed by the illustrative embodiments of the present invention are not the exclusive sequence which may be employed within the scope of the present invention.

We claim:

1. In an electronic device, a method, comprising the steps of:
training a document classifier on a set of documents having labels, said labels identifying document categories;
performing an analysis on a selected document without labels with said document classifier;
assigning a specified label to said selected document based on said analysis, said analysis comparing word occurrence in said selected document with word occurrence in said set of documents having labels; and
determining the accuracy of the specified label assigned to said selected document.

2. The method of claim 1 wherein the step of determining the accuracy of the specified label assigned to said selected document, comprises the further steps of:
determining a probability for a word vector of said selected document being produced by the category referenced by said specified label, said word vector being a weighted set of words contained in said selected document; and
calculating the probability said selected document was generated by the category identified by said specified label using the probability of the word vector of said selected document being produced by the category referenced by said specified label and a length of said selected document; and
comparing the calculated probability said selected document was generated by the category identified by said specified label with a pre-defined parameter in order to determine a confidence level for the accuracy of said specified label assigned to said selected document.

3. The method of claim 2 wherein said pre-defined parameter is set by a user of said electronic device.

4. The method of claim 2, comprising the further steps of:
determining said confidence level exceeds said pre-defined parameter; and
mapping said word vector from said selected document to the document category identified by said specified label in said document classifier.

5. The method of claim 2, comprising the further steps of:
determining said confidence level does not exceed said parameter; and
preventing mapping of said word vector from said selected document to the document category identified by said specified label based on the determination said confidence level does not exceed said parameter.

6. The method of claim 1, comprising the further steps of:
determining average mutual information (AMI) for said set of documents having labels, said AMI being the average for each document of a degree of uncertainty in a labeling classification that is resolved by a presence of a word in a document;
determining the AMI for said selected document;
comparing the AMI for said set of documents having labels with the AMI for said selected document in order to determine a confidence level for the accuracy of the specified label assigned to said selected document.

7. The method of claim 6 wherein a value representing a document length is used to calculate AMI.

8. The method of claim 6, comprising the further steps of:
determining said confidence level exceeds a pre-defined parameter so that a word vector in said selected document and said specified label assigned to said selected document may be used to train said document classifier; and
mapping the word vector from said selected document to a document category identified by said specified label in said document classifier.

9. The method of claim 1 wherein said document classifier is a Bayesian document classifier.

10. In an electronic device, a method, comprising the steps of:
training a learning system on a set of documents, each of said documents being a collection of data, said labels identifying document categories;
performing an analysis on a selected document without labels with said learning system;
assigning a specified label to the selected document based on said analysis, said analysis comparing word occurrence in said selected document with word occurrence in said set of documents; and
determining the accuracy of the specified label assigned to said selected document.

11. The method of claim 10, comprising the further steps of:
multiplying together a probability for each word in said selected document being generated by the document category identified by said specified label, said probability based on a frequency of a word appearing in documents having the specified label in said set of documents, said multiplying resulting in an overall product result;
calculating a probability said selected document was generated by the category identified by the specified label using said overall product result and a word length for said selected document; and
comparing the calculated probability with a pre-defined parameter in order to determine a confidence level for the accuracy of the specified label assigned to said selected document.

12. The method of claim 11 wherein a probability for all of the words not occurring in said selected document not being generated by the document category identified by the specified label is used to calculate said overall product.

13. The method of claim 11 wherein said pre-defined parameter is set by a user of said electronic device.

14. The method of claim 11, comprising the further steps of:
determining said confidence level exceeds said pre-defined parameter; and
mapping a word vector from said selected document to a document category identified by said specified label assigned to said selected document by said learning system, said mapping further training said learning system.

15. The method of claim 11, comprising the further steps of:
determining said confidence level does not exceed said pre-defined parameter; and
preventing mapping of a word vector from said selected document to a document category identified by the specified label assigned to said selected document in said learning system based on the determination said confidence level does not exceed said pre-defined parameter.

16. The method of claim 10, comprising the further steps of:
determining average mutual information (AMI) for said set of documents, said AMI being the average for each document of a degree of uncertainty in a labeling classification that is resolved by a presence of a word in a document;
determining the AMI for said selected document;
comparing the AMI for said set of documents with the AMI for said selected document in order to determine a confidence level for the accuracy of the specified label assigned to said selected document.

17. The method of claim 16 wherein a value representing the length of a document is used in the calculation of AMI.

18. The method of claim 16, comprising the further steps of:
determining said AMI for said selected document exceeds the AMI for said set of documents by a pre-defined margin; and
mapping a word vector from said selected document to a document category identified by the specified label assigned to said selected document by said learning system, said mapping further training said learning system.

19. In a network that includes an electronic device, a method, comprising the steps of:
training a document classifier on a set of documents having labels, said labels identifying document categories and said documents being accessible over said network;
analyzing a selected document with said document classifier;
assigning a specified label to said selected document based on said analyzing, said analyzing comparing word occurrence in said selected document with word occurrence in said set of documents having labels; and
determining the accuracy of the specified label assigned to said selected document.

19. The method of claim 18, comprising the further step of:
comparing a calculated probability said selected document was generated by the category referenced by said specified label with a pre-defined parameter in order to determine a confidence level for the accuracy of the specified label assigned to said selected document.

20. The method of claim 19, comprising the further steps of:
comparing a value representing the average mutual information (AMI) for said set of documents having labels with a value representing the AMI for said selected document, said AMI being the average of a degree of uncertainty in a labeling classification that is resolved by the presence of a word in a document;
generating a confidence level in the accuracy of the specified label assigned to said selected document based on the comparison;
comparing said confidence level against a user-defined parameter; and
using a word vector from said selected document to further train said document classifier.

21. In an electronic device, a medium holding computer-executable steps for a method, said method comprising the steps of:
training a document classifier on a set of documents having labels, said labels identifying document categories, said documents accessible over said network;
analyzing a selected document with said document classifier;
assigning a specified label to said selected document based on said analyzing, said analyzing comparing word occurrence in said selected document with word occurrence in said set of documents having labels;
determining the accuracy of the specified label assigned to said selected document; and
using a word vector in said selected document to further train said document classifier.

22. The medium of claim 21 wherein said electronic device is interfaced with a network.

23. The medium of claim 22 wherein said method comprises the further steps of:
accessing said set of documents over said network; and
accessing said selected document over said network.
